(19) United States
(12) Patent Application Publication
(10) Pub. No.: US 2023/0047862 A1
(43) Pub. Date: Feb. 16, 2023

(54) SEGMENTED STATOR CORE DESIGN

(71) Applicant: GM Global Technology Operations LLC, Detroit, MI (US)

(72) Inventors: Jian Yao, Shanghai (CN); Chengwu Duan, Shanghai (CN); Yusheng Zou, Northville, MI (US)

(21) Appl. No.: 17/401,663

(22) Filed: Aug. 13, 2021

(51) Int. Cl. H02K 3/52; H02K 15/03; H02K 1/14

(52) U.S. Cl. CPC H02K 3/522; H02K 15/03; H02K 1/148

(57) ABSTRACT

A stator core assembly for an axial flux electric motor for an automobile includes a cylindrical outer case that defines a central axis, and a plurality of segmented core sections spaced circumferentially around the central axis within the outer case, each of the segmented core sections including a lamination stack and a sleeve, the lamination stack being positioned within the sleeve and the sleeve being formed from a soft magnetic composite material, the sleeve of each of the plurality of segmented core sections including a first axial end having a pole shoe formed thereon and a second axial end having a pole shoe formed thereon, the pole shoes formed on the first and second axial ends of the sleeve of each of the plurality of segmented core sections including a radially outward surface having an arcuate shape that corresponds to and contacts the radially inward surface of the outer case.

### INTRODUCTION

The present disclosure relates to an axial flux electric motor for use in an automobile, and more particularly to a stator core for an axial flux electric motor that includes features that extend radially outward and contact an inner radial surface of an outer case.

An electric motor is a machine that transforms electrical energy into mechanical energy by means of the action of the magnetic fields generated in its coils. An electric motor creates rotational, or circular, motion. The central part of the motor is a cylinder called the armature or rotor. The rotor is the part of the motor that spins. An axial flux motor (also known as an axial gap motor, or pancake motor) is a geometry of motor construction where the gap between the rotor and stator, and therefore the direction of magnetic flux between the two, is aligned parallel with the axis of rotation, rather than radially as with the concentric cylindrical geometry of the more common radial gap motor. In an axial flux electric motor, the stator is positioned next to the rotor and holds insulated coils of wire, usually copper. When a current is applied to the motor, the stator generates a magnetic field that drives the rotor.

In a segmented stator, stator core sections that are magnetically separated from one another form the stator. Often, epoxy is used to support the segmented core sections within an outer case. While epoxy provides good insulation, epoxy does not effectively conduct heat from the segmented core sections to the outer case. In some cases, segmented core sections are formed with pole shoes that can be used to support the segmented core sections directly on the outer case. A problem with this configuration is that it is difficult to form pole shoes in a lamination stack. To reduce core loss, lamination stacks are preferable.

Thus, while current segmented stator core assemblies and electric motors having segmented stator core assemblies achieve their intended purpose, there is a need for a new and improved segmented stator core assembly that includes segmented core sections having both lamination stacks and pole shoes to provide lower core loss and effective cooling of the segmented core sections.

### SUMMARY

According to several aspects of the present disclosure, an axial flux electric motor for an automobile includes a rotor assembly, and a stator assembly, the stator assembly including a cylindrical outer case that defines a central axis, and a plurality of segmented core sections spaced circumferentially around the central axis and within the outer case, wherein, each of the plurality of segmented core sections extends radially outward and contacts a radially inward inner surface of the outer case.

According to another aspect, each of the plurality of segmented core sections includes a lamination stack and a sleeve, the lamination stack being positioned within the sleeve.

According to another aspect, the sleeve of each of the plurality of segmented core sections includes a first axial end having a pole shoe formed thereon and a second axial end having a pole shoe formed thereon, the pole shoes formed on the first and second axial ends of the sleeve of each of the plurality of segmented core sections including a radially outward surface having an arcuate shape that corresponds to and contacts the radially inward surface of the outer case.

According to another aspect, the sleeve of each of the plurality of segmented core sections comprises a soft magnetic composite material.

According to another aspect, the laminate stack of each of the plurality of segmented core sections is one of exposed at the first and second axial ends of the sleeve, and completely enclosed within the sleeve, and one of trapezoidal in shape and stepped.

According to still another aspect, the pole shoes formed at the first and second axial ends of each of the plurality of segmented core sections define a plurality of slot openings, one slot opening positioned between each adjacent pair of segmented core sections, each of the plurality of slot openings being one of straight and defining a radial axis that intersects the central axis of the segmented stator core, straight and defining a radial axis that does not intersect with a central axis of the segmented stator core, V-shaped, and Z-shaped.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an exploded view of an axial flux electric motor according to an exemplary embodiment;

FIG. 2 is a perspective view of a stator core assembly in accordance with an exemplary embodiment;

FIG. 3 is a perspective view of a segmented core section wherein a lamination stack is completely enclosed within a sleeve of the stator core section;

FIG. 4 is a perspective view of a segmented core section wherein a lamination stack is exposed at first and second axial ends of the stator core section and is trapezoidal shaped;

FIG. 5 is a perspective view of a segmented core section wherein a lamination stack is exposed at first and second axial ends of the stator core section and is stepped;

FIG. 6 is a perspective view of a stator core assembly having slot openings between adjacent segmented core sections that are inclined;

FIG. 7 is a perspective view of a stator core assembly having slot openings between adjacent segmented core sections that are Z-shaped; and

FIG. 8 is a perspective view of a stator core assembly having slot openings between adjacent segmented core sections that are V-shaped.

### DETAILED DESCRIPTION

The following description is merely exemplary in nature and is not intended to limit the present disclosure, application, or uses.

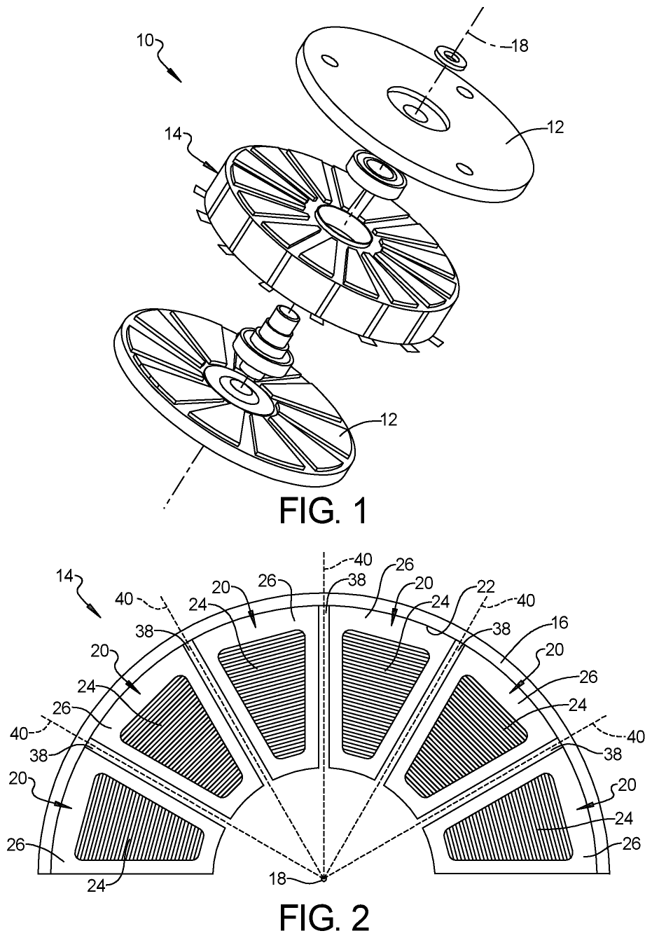

Referring to FIG. 1, an axial flux electric motor 10 for an automobile includes a rotor assembly 12 and a stator core assembly 14. The rotor assembly 12 may include a single rotor 12 positioned adjacent the stator core assembly 14, or, alternatively, the rotor assembly 12 may include two rotors 12, one positioned on either side of the stator core assembly 14, as shown in FIG. 1.

Referring to FIG. 2, the stator core assembly 14 includes a cylindrical outer case 16 that defines a central axis 18. A plurality of segmented core sections 20 are spaced circumferentially around the central axis 18 and within the outer case 16. The plurality of segmented core sections 20 are positioned in an annular pattern. As shown, the stator core assembly 14 includes twelve segmented core sections 20 (six are shown in the partial view of FIG. 2). It should be understood that a stator core assembly 14 in accordance with the present disclosure could include any suitable number of segmented core sections 20.

Each of the plurality of segmented core sections 20 extends radially outward and contacts a radially inward inner surface 22 of the outer case 16. The outer case 16 provides support for the plurality of segmented core sections 20 and provides a path for heat to be removed from the stator core assembly 14.

Each of the segmented core sections 20 includes a lamination stack 24 and a sleeve 26. The lamination stack 24 is positioned within and supported by the sleeve 26. The sleeve 26 of each of the plurality of segmented core sections 20 includes a trapezoidal shaped central bar 28, a first axial end 30 having a pole shoe 32 formed thereon and a second axial end 34 having a pole shoe 32 formed thereon. The pole shoes 32 formed on the first and second axial ends 30, 34 of the sleeve 26 of each of the plurality of segmented core sections 20 include a radially outward surface 36 having an arcuate shape that corresponds to and contacts the radially inward surface 22 of the outer case 16.

The lamination stack 24 is comprised of a plurality of lamination plates that are formed from a ferrous material, such as, but not limited to lamination steel or non-oriented electrical steel, to provide magnetic conductivity for flux currents during operation of the electric motor 10. During operation of the electric motor 10, heat is generated due to the flux currents flowing through the lamination stacks 24.

Smooth contact between the radially outward surface 36 of each of the pole shoes 32 against the radially inward surface 22 of the outer case 16 ensures maximum surface contact between the two surfaces and maximizes conduction of heat from the lamination stacks 24 through the pole shoes 32 and to the outer case 16 within each segmented core section 20. In an exemplary embodiment, the outer case 16 includes a water jacket formed therein to allow coolant to flow through the outer case 16 and transfer heat out of the stator core assembly 14.

In an exemplary embodiment, the sleeve 26 and the pole shoes 32 are formed from a soft magnetic composite material (“SMC”). The manufacturability of the SMC material allows formation of pole shoes 32 and provides good conductivity for the transfer of heat away from the lamination stacks 24.

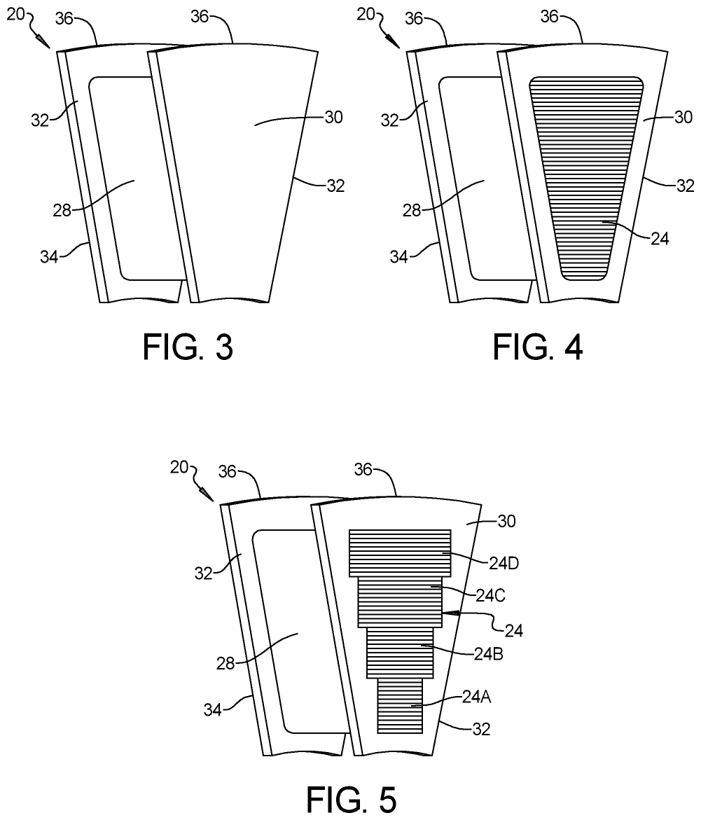

Referring to FIG. 3, in one exemplary embodiment, the lamination stack 24 is completely enclosed within the sleeve 26. Referring to FIG. 4, in another exemplary embodiment, the laminate stack 24 of each of the plurality of segmented core sections 20 is exposed at the first and second axial ends 30, 34 of the sleeve 26.

Referring again to FIG. 4, in another exemplary embodiment, the lamination stack 24 has a trapezoidal shape. Referring to FIG. 5, in still another exemplary embodiment, the lamination stack 24 is stepped. The stepped lamination stack 24 includes multiple groups of lamination plates having differing widths. As shown in FIG. 5, the lamination stack 24 includes a first group 24A of lamination plates have a first width, a second group 24B of lamination plates having a width greater than the width of the first group 24A, a third group 24C of lamination plates having a width greater than the width of the second group 24B, and a fourth group 24D of lamination plates having a width greater than the width of the third group 24C. The four groups 24A, 24B, 24C, 24D of lamination plates are stacked adjacent one another to form the stepped lamination stack 24.

Referring again to FIG. 2, the pole shoes 32 formed at the first and second axial ends 30, 34 of each of the plurality of segmented core sections 20 define a plurality of slot openings 38, one slot opening 38 is positioned between each adjacent pair of segmented core sections 20. One slot opening 38 is positioned between the pole shoes 32 of the first axial ends 30 of each adjacent pair of segmented core sections 20, and one slot opening 38 is positioned between the pole shoes 32 of the second axial ends 34 of each adjacent pair of segmented core sections 20.

It should be understood that the Figures are representative of either the first axial ends 30 of the plurality of segmented core sections 20 or the second axial ends 34 of the plurality of segmented core sections 20. The pole shoes 32 of the first and second axial ends 30, 34 of the segmented core sections 20 are identical.

Referring again to FIG. 2, in an exemplary embodiment, each of the slot openings 38 are straight. As shown, each of the slot openings 38 define a radial axis 40 that intersects the central axis 18 of the stator core assembly 14. For each of the plurality of segmented core sections 20, the pole shoes 32 are centrally aligned with the central bar 28.

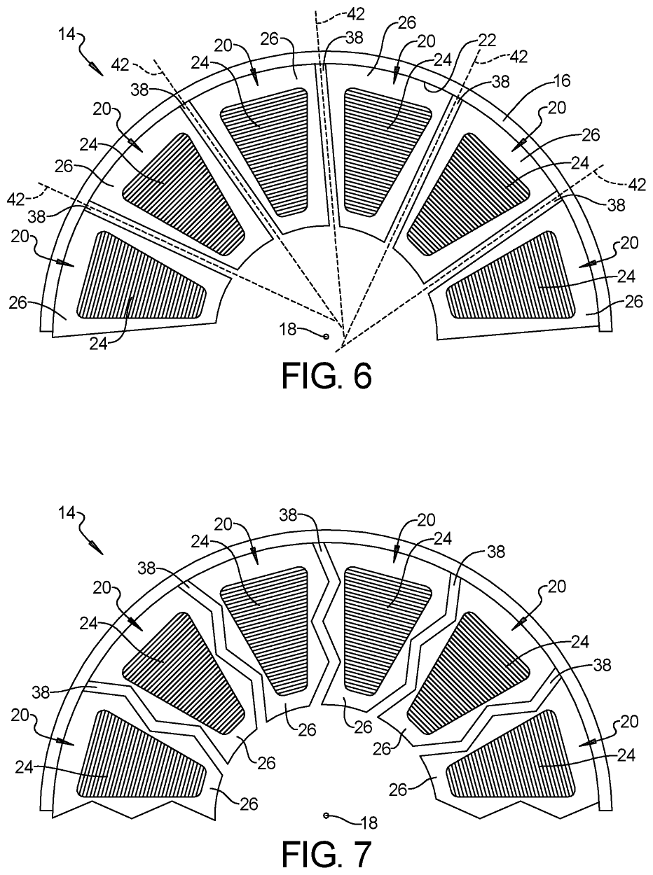

Referring to FIG. 6, in another exemplary embodiment, each of the slot openings 38 are straight and inclined and define a radial axis 42 that does not intersect with the central axis 18 of the stator core assembly 14. To accommodate the inclined nature of the slot openings 38, for each of the plurality of segmented core sections 20 the pole shoes 32 are skewed with respect to the central bar 28. This exemplary embodiment provides less cogging of the electric motor 10.

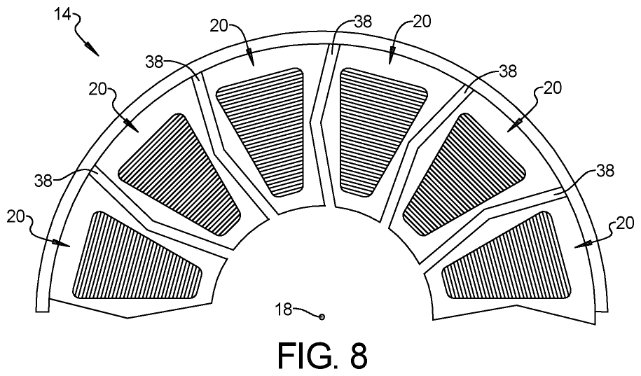

Referring to FIG. 7, in another exemplary embodiment, each of the slot openings 38 are Z-shaped. Referring to FIG. 8, in still another exemplary embodiment, each of the slot openings 38 are V-shaped. To accommodate the V-shaped slot openings 38, for each of the plurality of segmented core sections 20 the pole shoes 32 are also V-shaped. This exemplary embodiment provides less cogging of the electric motor 10.

A stator core assembly 14 and an electric motor 10 having a stator core assembly 14 in accordance with the present disclosure takes advantage of the manufacturability and heat conductive characteristics of soft magnetic composite materials by using SMC for the sleeve 26 and pole shoes 32 and utilizing a lamination stack 24 to provide the performance benefits of a lamination stack 24 along with the thermal management advantages of pole shoes 32 that extend radially outward to contact the outer case 16. In addition, the manufacturability of SMC allows pole shoes 32 to be designed that define inclined and shaped slot openings 38 between adjacent pairs of segmented core sections 20 to provide reduced cogging torque within the electric motor 10 during operation.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A stator core assembly for an axial flux electric motor for an automobile, comprising:
a cylindrical outer case that defines a central axis; and
a plurality of segmented core sections spaced circumferentially around the central axis and within the outer case;
wherein, each of the plurality of segmented core sections extends radially outward and contacts a radially inward inner surface of the outer case.

2. The stator core assembly of claim 1, wherein each of the plurality of segmented core sections includes a lamination stack and a sleeve, the lamination stack being positioned within the sleeve.

3. The stator core assembly of claim 2, wherein the sleeve of each of the plurality of segmented core sections includes a first axial end having a pole shoe formed thereon and a second axial end having a pole shoe formed thereon, the pole shoes formed on the first and second axial ends of the sleeve of each of the plurality of segmented core sections including a radially outward surface having an arcuate shape that corresponds to and contacts the radially inward surface of the outer case.

4. The stator core assembly of claim 3, wherein the sleeve of each of the plurality of segmented core sections comprises a soft magnetic composite material.

5. The stator core assembly of claim 4, wherein the laminate stack of each of the plurality of segmented core sections is exposed at the first and second axial ends of the sleeve.

6. The stator core assembly of claim 4, wherein the laminate stack of each of the plurality of segmented core sections is completely enclosed within the sleeve.

7. The stator core assembly of claim 4, wherein the laminate stack is trapezoidal in shape.

8. The stator core assembly of claim 4, wherein the laminate stack is stepped.

9. The stator core assembly of claim 4, wherein the pole shoes formed at the first and second axial ends of each of the plurality of segmented core sections define a plurality of slot openings, one slot opening positioned between each adjacent pair of segmented core sections.

10. The stator core assembly of claim 9, wherein each of the plurality of slot openings are straight.

11. The stator core assembly of claim 10, wherein each of the plurality of slot openings define a radial axis that intersects the central axis of the segmented stator core.

12. The stator core assembly of claim 10, wherein each of the plurality of slot openings define a radial axis that does not intersect with a central axis of the segmented stator core.

13. The stator core assembly of claim 9, wherein each of the plurality of slot openings are one of v-shaped or z-shaped.

14. An axial flux electric motor for an automobile, comprising:
a rotor assembly, and
a stator assembly, the stator assembly including:
a cylindrical outer case that defines a central axis; and
a plurality of segmented core sections spaced circumferentially around the central axis and within the outer case;
wherein, each of the plurality of segmented core sections extends radially outward and contacts a radially inward inner surface of the outer case.

15. The axial flux electric motor of claim 14, wherein each of the plurality of segmented core sections includes a lamination stack and a sleeve, the lamination stack being positioned within the sleeve.

16. The axial flux electric motor of claim 15, wherein the sleeve of each of the plurality of segmented core sections includes a first axial end having a pole shoe formed thereon and a second axial end having a pole shoe formed thereon, the pole shoes formed on the first and second axial ends of the sleeve of each of the plurality of segmented core sections including a radially outward surface having an arcuate shape that corresponds to and contacts the radially inward surface of the outer case.

17. The axial flux electric motor of claim 16, wherein the sleeve of each of the plurality of segmented core sections comprises a soft magnetic composite material.

18. The axial flux electric motor of claim 17, wherein the laminate stack of each of the plurality of segmented core sections is one of exposed at the first and second axial ends of the sleeve, and completely enclosed within the sleeve, and one of trapezoidal in shape and stepped.

19. The axial flux electric motor of claim 18, wherein the pole shoes formed at the first and second axial ends of each of the plurality of segmented core sections define a plurality of slot openings, one slot opening positioned between each adjacent pair of segmented core sections, each of the plurality of slot openings being one of:
straight and defining a radial axis that intersects the central axis of the segmented stator core;
straight and defining a radial axis that does not intersect with a central axis of the segmented stator core;
V-shaped; and
Z-shaped.

20. A stator core assembly for an axial flux electric motor for an automobile, comprising:
a cylindrical outer case that defines a central axis; and
a plurality of segmented core sections spaced circumferentially around the central axis and within the outer case, each of the plurality of segmented core sections including a lamination stack and a sleeve, the lamination stack being positioned within the sleeve and the sleeve being formed from a soft magnetic composite material;
wherein, the laminate stack of each of the plurality of segmented core sections is one of exposed at the first and second axial ends of the sleeve, and completely enclosed within the sleeve, and one of trapezoidal in shape and stepped;
the sleeve of each of the plurality of segmented core sections including a first axial end having a pole shoe formed thereon and a second axial end having a pole shoe formed thereon, the pole shoes formed on the first and second axial ends of the sleeve of each of the plurality of segmented core sections including a radially outward surface having an arcuate shape that corresponds to and contacts the radially inward surface of the outer case; and
the pole shoes formed at the first and second axial ends of each of the plurality of segmented core sections defining a plurality of slot openings, one slot opening positioned between each adjacent pair of segmented core sections, each of the slot openings being one of straight and defining a radial axis that intersects the central axis of the segmented stator core, straight and defining a radial axis that does not intersect with a central axis of the segmented stator core, V-shaped, and Z-shaped.
